(19) United States
(12) Patent Application Publication
(10) Pub. No.: US 2009/0193700 A1
(43) Pub. Date: Aug. 6, 2009

(54) Distance marking device for a golf course

(76) Inventor: Owen Flannery, East Hampton, CT (US)

Correspondence Address: THE LAW OFFICES OF STEVEN MCHUGH, LLC, 46 WASHINGTON STREET, MIDDLETOWN, CT, 06457, US

(21) Appl. No.: 12/322,464

(22) Filed: Feb. 2, 2009

Related U.S. Application Data
(60) Provisional application No. 61/063,277, filed on Feb. 1, 2008.

(51) Int. Cl. G09F 15/00

(52) U.S. Cl. 40/608

(57) ABSTRACT

A marking device and a method for implementing the marking device is provided, where the marking device includes a marker base configured to be positioned within soil and a marker visual element, wherein the marker visual element is movably configurable between a first configuration and a second configuration relative to the marker base, wherein when the marker visual element is in the first configuration, the marker visual element is not easily seen from a distance and when the marker visual element is in the second configuration, the marker visual element is easily seen from a distance.

### CROSS REFERENCE TO RELATED APPLICATIONS

This application claims the benefit of U.S. Provisional Patent Application No. 61/063,277, filed Feb. 1, 2008 and entitled “Distance Marking Device for a Golf Course” the contents of which are incorporated herein by reference in its entirety.

### FIELD OF THE INVENTION

This invention relates generally to an article for indicating the distance between points on a golf course and more particularly to an article which is easily configurable between a stowed configuration and an un-stowed configuration to allow for easy maintenance of grounds without having to move the article.

### BACKGROUND OF THE INVENTION

To successfully negotiate the fairways of a golf course a player must accurately gauge the distance between the ball and the pin. One way to accomplish this is to use distance markers that are typically located within the golf course fairway. These distance markers are well known in the golfing industry and are used by almost all golf courses to indicate to the golfer where his/her ball lies on the fairway in relation to the pin. This allows the golfer to judge which club to use and how hard to hit the ball. If the wrong club is chosen or if an improper amount of force is used to strike the ball, the golfer may overshoot or undershoot the green. Accordingly, it is necessary that these distance markers accurately reflect the distance between known points on the fairway and the cup/pin.

There are several different types of fairway markers that are currently being used to mark distances between points on a fairway. One type of marking device includes colored plastic markers that are disposed within the ground of the fairway and that protrude slightly above the ground. Unfortunately, these types of markers are not easily seen from a distance and the players must then walk the fairways to locate the markers. Once the markers are located, the players must locate their ball (which depending on the fairway layout may not be easily visible) and judge the distance between the ball and the marker. This is undesirable because in certain situations the marker and ball may not be visible to the player simultaneously making it difficult to accurately judge the distance between the ball and the marker.

Another type of marking device includes non-movable objects, such as trees or rocks that are positioned along the sides or within the fairway. This is undesirable for a couple of reasons. First, if the marker is a natural object, such as a tree or bush, the player is left to guess whether it is actually a marker or a naturally occurring object. Second, if the marker is located within the fairway it becomes a hindrance to maintenance personnel who must mow around the marker device.

Still yet other types of marking devices include movable objects that are positioned next to or within the fairway. These devices typically stick up from the ground by about 1½ feet and are clearly visible by the players on the course. Unfortunately, these markers are a hindrance to maintenance personnel who must remove and replace the markers before and after mowing to prevent damaging the markers. And in some situations, the markers may be mistakenly located in a different location. This is undesirable because it increases the maintenance time of the fairways and because it puts in doubt the accuracy of the distance between the marker and the pin.

### SUMMARY OF THE INVENTION

A marking device is provided and includes a marker base configured to be positioned within soil. The marking device further includes a marker visual element, wherein the marker visual element is movably configurable between a first configuration and a second configuration relative to the marker base. When the marker visual element is in the first configuration, the marker visual element is disposed substantially parallel with a plane of the soil, and when the marker visual element is in the second configuration, the marker visual element is disposed substantially perpendicular with the plane of the soil.

A marking device is provided and includes a marker base configured to be positioned within soil. The marking device also includes a marker visual element, wherein the marker visual element is movably configurable between a first configuration and a second configuration relative to the marker base. When the marker visual element is in the first configuration, the marker visual element is configured to be retracted within the marker base, and when the marker visual element is in the second configuration, the marker visual element is configured to be extended from the marker base to be substantially perpendicular with a plane of the soil.

A method for marking distance on a golf course is provided wherein the method includes positioning a marking device at a predetermined position on the golf course and configuring the marking device between a first configuration and a second configuration. The marking device includes, a marker base configured to be positioned within soil and a marker visual element, wherein the marker visual element is movably configurable between the first configuration and the second configuration relative to the marker base, wherein when the marker visual element is in the first configuration, the marker visual element is disposed substantially parallel with a plane of the soil, and when the marker visual element is in the second configuration, the marker visual element is disposed substantially perpendicular with the plane of the soil.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 is a side view of a distance marker located in the fairway of a golf course in a first configuration, in accordance with a first embodiment of the present invention.

FIG. 2 is a side view of the distance marker of FIG. 1 showing a lawn mower approaching.

FIG. 3 is a side view of the distance marker of FIG. 1 showing a lawn mower going over the distance marker of FIG. 1.

FIG. 4 is a side view of the distance marker of FIG. 1 in a second configuration, in accordance with a first embodiment of the present invention.

FIG. 5 is a side view of the distance marker of FIG. 1 being configured between the first configuration and the second configuration, in accordance with a first embodiment of the present invention.

FIG. 6 is a side view of a distance maker located in the fairway of a golf course, in accordance with a second embodiment of the present invention.

FIG. 7 is a side view of the distance marker of FIG. 6 showing a lawn mower approaching.

FIG. 8 is a side view of the distance marker of FIG. 6 showing a lawn mower going over the distance marker of FIG. 6.

FIG. 9 is a side view of the distance marker of FIG. 6 being configured between the first configuration and the second configuration, in accordance with a second embodiment of the present invention.

FIG. 10 is a block diagram illustrating a method for implementing the distance marker, in accordance with the present invention.

### DETAILED DESCRIPTION OF THE INVENTION

As disclosed herein with regards to an exemplary embodiment, an easy to implement golf course distance marker is provided in accordance with the present invention, wherein the distance marker is configurable between a stowed configuration and an un-stowed configuration to allow for maintenance of a golf course fairway without having to remove and replace the distance marker during routine golf course maintenance.

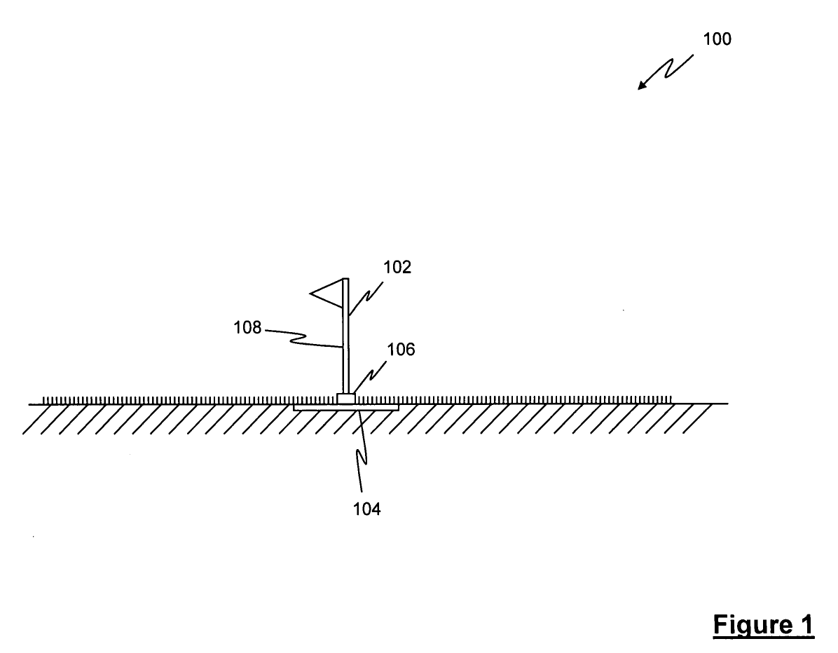

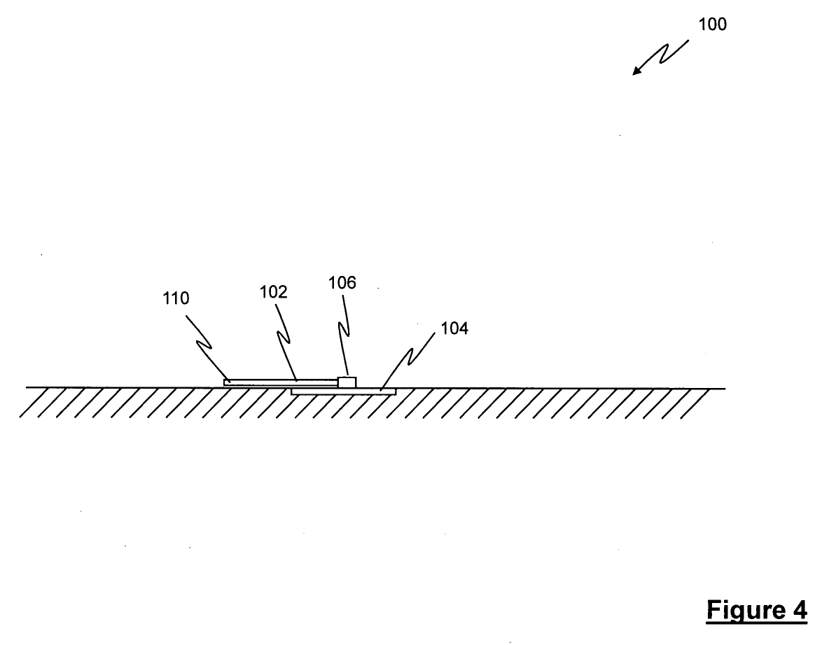

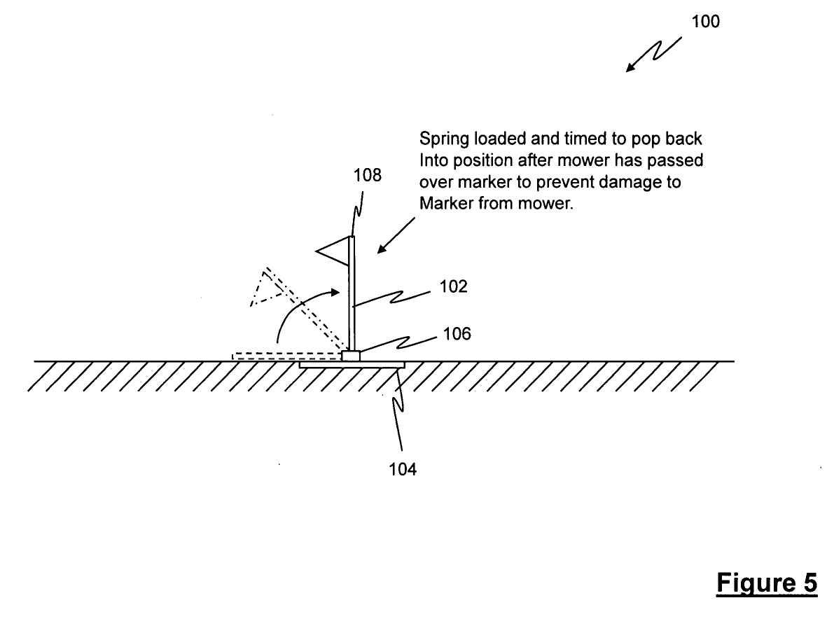

Referring to FIG. 1, a first embodiment of a distance marker 100 in accordance with the present invention is shown and includes a visual element 103, in this case a marker pole 102 having a flag, and a marker base 104. The marker pole 102 is movably associated with the marker base 104 via a configuration device 106 to be configurable between a first configuration 108 and a second configuration 110, wherein in the first configuration 108, the configuration device 106 is configured to allow the marker pole 102 to lay in a position parallel to the ground of the fairway for a predetermined period of time, as shown in FIGS. 4 and 5. The configuration device 106 may accomplish this via any method suitable to the desired end purpose, such as via a spring-latch combination. Because the marker device 100 is disposed in the soil in a position such that the marker base 104 is substantially parallel and flush to the ground of the fairway, when the grounds are being mowed, the mower simply passes over the marker device 100 without damaging the marker device 100. This allows the area around the marker device 100 to be mowed without having to remove the marker device 100 prior to mowing and replace the marker device 100 after mowing. It is contemplated that the flag on the marker visual element may be retractable as desired. For example, the flag may be retracted when the marker visual element 103 is in the first configuration 108 and extended when the marker visual element 103 is in the second configuration 110. Also, other types of elements may be associated with the marker pole 102 as desired, such as reflector elements/coatings and/or lights. Also, the marker pole 102 may be constructed of a material that is visibly noticeable from a distance.

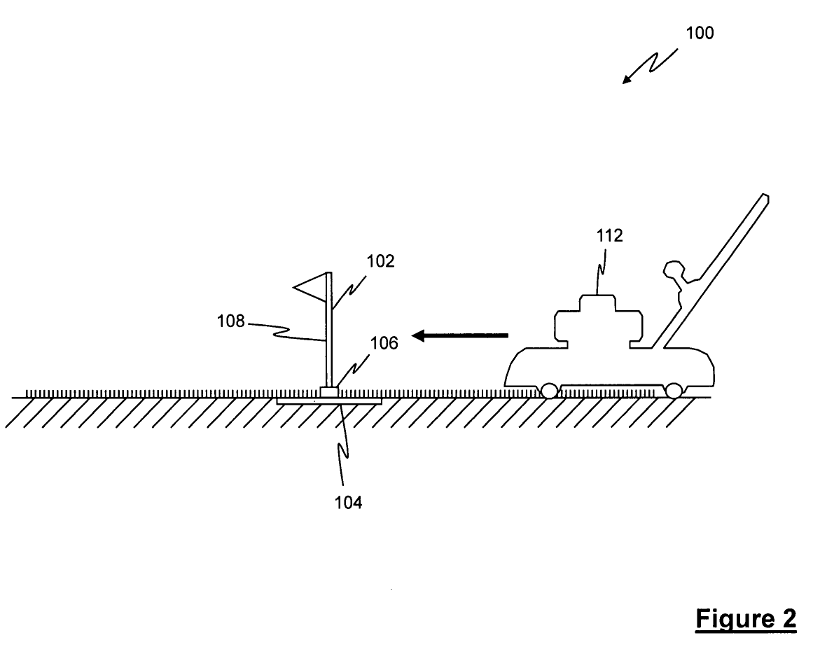

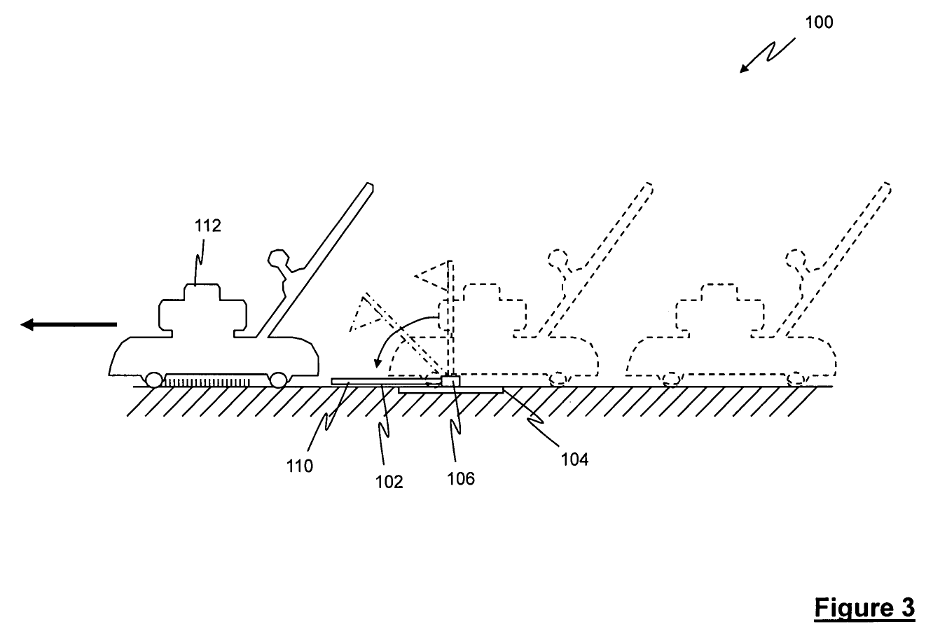

For example, referring to FIGS. 2-5 in accordance with the first embodiment, the marker device 100 may function as follows. As shown in FIGS. 2-4, as a mowing device 112 approaches the grassy area surrounding the marking device 100, the front portion 114 of the mowing device 112 causes the marker pole 102 (such as by pushing the marker pole 102) to pivot from a vertical position (i.e. first configuration 108) into a horizontal position (i.e. second configuration 110). When the marker pole 102 is configured into the second configuration 110, the configuration device 106 keeps the marker pole 102 in this position for a predetermined period of time to allow the mower to finish mowing the area around the marker device 100. After the predetermined period of time, the configuration device 106 springingly configures the marker pole 102 from the second configuration 110 into the first configuration 108. It is contemplated that the marker

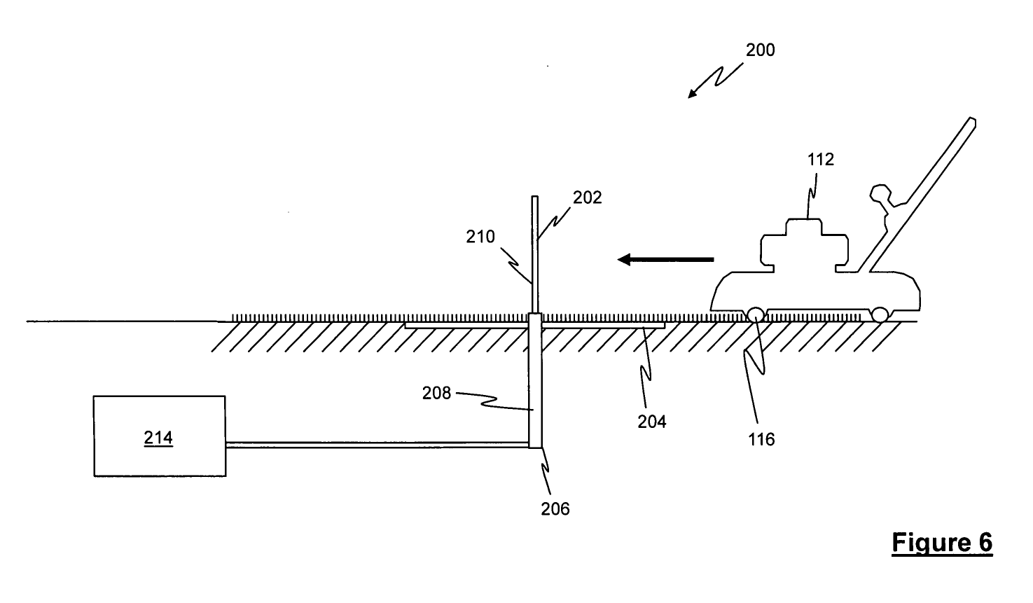

Referring to FIG. 6, a second embodiment of a distance marker 200 in accordance with the present invention is shown and includes a marker pole 202, a marker base 204 and a configuration device 206 having a configuration device cavity 208. The marker pole 202 is movably associated with the marker base 204 via the configuration device 206 to be configurable between a first configuration 210 and a second configuration 212. When the marker pole 202 is configured in the first configuration 210, the marker pole 202 is disposed outside of the configuration device cavity 208 and when the marker pole 202 is configured in the second configuration 212, the marker pole 202 is disposed within the configuration device cavity 208. In one embodiment the marker pole 202 may be configured from the first configuration 210 into the second configuration 212 using a gravity feed set up (i.e. by triggeringly letting the marker pole 202 drop into the configuration device cavity 208 via gravity) and in another embodiment this may be accomplished using a set up that actively retracts the marker pole 202 into the configuration device cavity 208. It is contemplated that the configuration device 206 may include a control module associated (directly or indirectly) with the marker pole 202 to cause the marker pole 202 to configure between the first configuration 210 and the second configuration 212 via a (such as a electrical hardwired or wireless) signal, which may generated via a automatic timing device, a motion sensor and/or a remote control device.

Additionally, the marker pole 202 may be configured from the second configuration 212 into the first configuration 210 via any method and/or device suitable to the desired end purpose, such as via a spring device, an air pressure device and/or a water pressure device 214. Because the distance marker 200 is disposed within the configuration device cavity 208, when the grounds are being mowed, the mower simply passes over the distance marker 200 without damaging the marker device 200. This allows the area around the marker device 200 to be mowed without having to remove the marker device 200 prior to mowing and replace the marker device 200 after mowing.

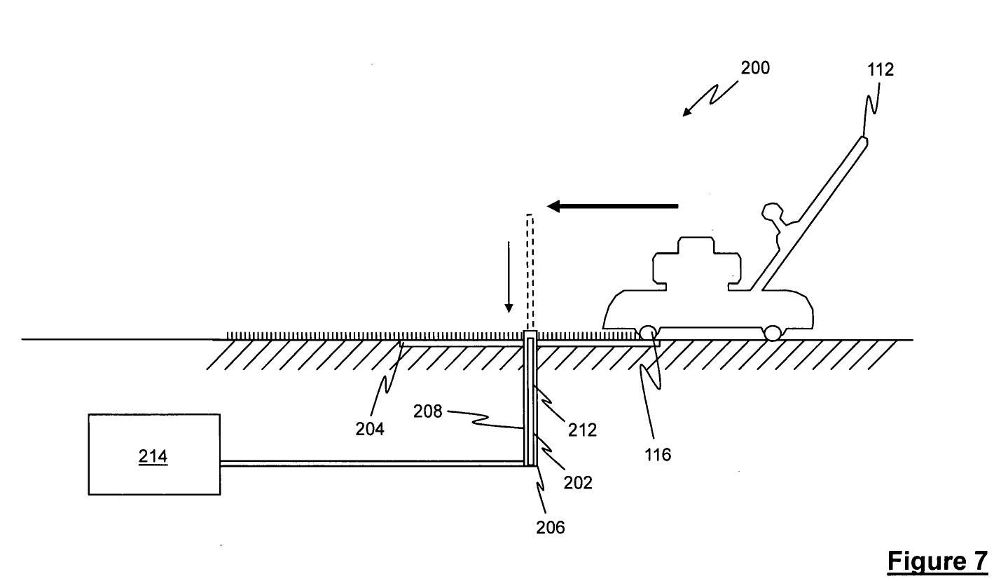

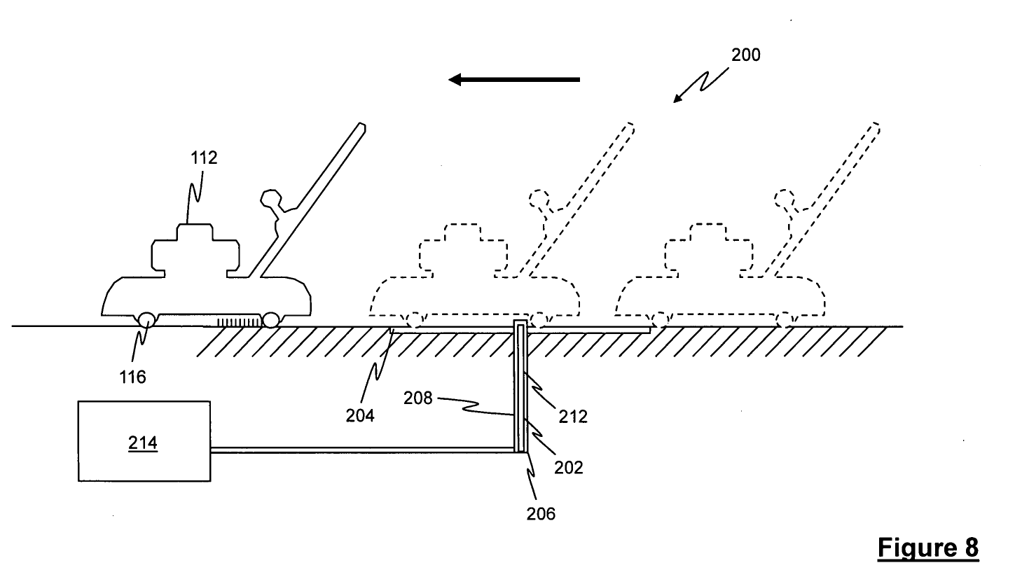

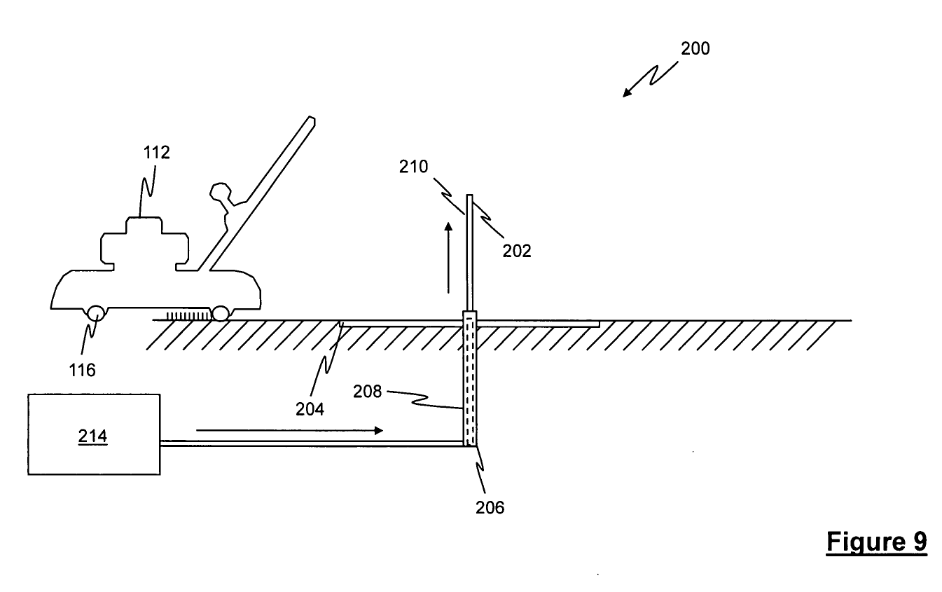

For example, referring to FIGS. 7-9 in accordance with the second embodiment, the marker device 200 may operate as follows. As shown in FIG. 7, as a mowing device 112 approaches the grassy area surrounding the marking device 200, the wheel portion 116 of the mowing device 112 rolls onto the marker base 204 which triggers a latch (not shown) within the configuration device 206 allowing the marker pole 202 to drop via gravity into the configuration device cavity 208 to configure the marker pole 202 between the first configuration 210 and the second configuration 212. As the mowing device 112 moves away from the marking device 200 a pressure source 216 may be activated that causes a pressure to be applied to the configuration device cavity 208 causing the marking pole 202 to be configured from the second configuration 212 into the first configuration 210.

In accordance with the present invention, it is contemplated that other configurations of the invention may be used. For example, marker pole 102, 202 may be configured to be telescoping to retract into the ground and/or to assume various heights as desired. Also, the marker pole 102, 202 and/or marking device 100, 200 may be configured to be used with any type of mowing device. Additionally, the marker pole 102, 202 and/or marking device 100, 200 may be configured to be removable for easy replacement and/or relocation.

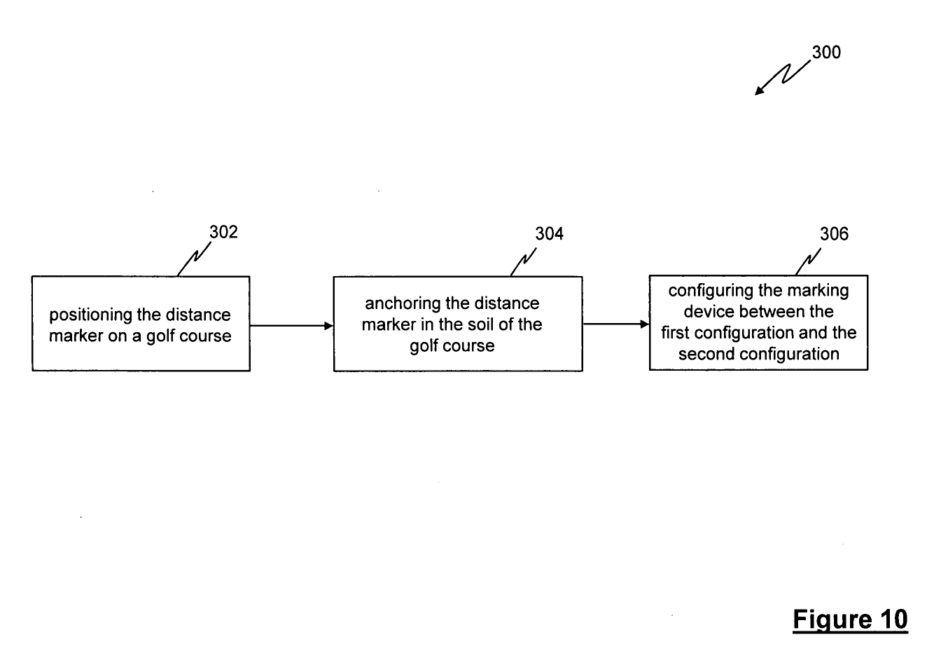

Referring to FIG. 10, a block diagram illustrating a method 300 for implementing a marking device 100, 200 is shown and includes positioning the marking device 100, 200 in on a golf course, as shown in operational block 302, anchoring the marking device 100, 200 in the soil of the golf course, as shown in operational block 304, and configuring the marking device 100, 200 between the first configuration 210 and the second configuration 212, as shown in operational block 306. It is contemplated that the marking device 100, 200 may be configured between the first configuration 210 and the second configuration 212 via manually or automatically via a timer device, a mechanical device and/or an electrical and/or a wireless signal.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

Additionally, it is contemplated that one or more distance marker devices may be controlled/operated, together and/or separately, via a remote and/or local control system, such as via a computer. The control system and/or computer may be operably connected with the marker devices via a hard wire connection and/or via a wireless connection to allow one or more marking devices to be automatically and/or manually controlled separately or together via one central location and/or via several locations.

What is claimed is:

1. A marking device, comprising:
a marker base configured to be positioned within soil; and
a marker visual element, wherein said marker visual element is movably configurable between a first configuration and a second configuration relative to said marker base, wherein
when said marker visual element is in said first configuration, said marker visual element is disposed substantially parallel with a plane of the soil, and
when said marker visual element is in said second configuration, said marker visual element is disposed substantially perpendicular with the plane of the soil.

2. The marking device of claim 1, wherein the marker base is configure to be flush with the plane of the soil.

3. The marking device of claim 1, wherein said marker visual element includes a flag that is retracted when the marker visual element is in the first configuration and extended when the marker visual element is in the second configuration.

4. The marking device of claim 1, further comprising a control module, wherein said control module is associated with said marker visual element to configure said marker visual element between said first configuration and said second configuration.

5. The marking device of claim 4, wherein said control module is associated with said marker visual element to configure said marker visual element between said first configuration and said second configuration via a remote signal.

6. The marking device of claim 4, wherein said control module is associated with said marker visual element to configure said marker visual element between said first configuration and said second configuration via an automatic timing device.

7. The marking device of claim 1, wherein said marker visual element is pivotably and springingly associated with said marker base to pivotably and springingly configure between said first configuration and said second configuration when run over by a grass mowing device.

8. The marking device of claim 7, wherein when said marker visual element is configured such that when said marker visual element is configured from said second configuration into said first configuration, said marker visual element remains in said first configuration for a predetermined period of time to allow said grass mowing device to clear said marker visual element.

9. The marking device of claim 8, wherein after said predetermined period of time has transpired, said marker visual element automatically configures between said first configuration and said second configuration.

10. A marking device, comprising:
a marker base configured to be positioned within soil; and
a marker visual element, wherein said marker visual element is movably configurable between a first configuration and a second configuration relative to said marker base, wherein
when said marker visual element is in said first configuration, said marker visual element is configured to be retracted within the marker base, and
when said marker visual element is in said second configuration, said marker visual element is configured to be extended from the marker base to be substantially perpendicular with a plane of the soil.

11. The marking device of claim 10, wherein the marker base is configure to be flush with the plane of the soil.

12. The marking device of claim 10, wherein marker visual element include a flag that is retracted when the marker visual element is in the first configuration and extended when the marker visual element is in the second configuration.

13. The marking device of claim 10, further comprising a control module, wherein said control module is associated with said marker visual element to configure said marker visual element between said first configuration and said second configuration.

14. The marking device of claim 13, wherein said control module is associated with said marker visual element to configure said marker visual element between said first configuration and said second configuration via a remote signal.

15. The marking device of claim 13, wherein said control module is associated with said marker visual element to configure said marker visual element between said first configuration and said second configuration via an automatic timing device.

16. The marking device of claim 10, wherein said marker visual element is pivotably and springingly associated with said marker base to pivotably and springingly configure between said first configuration and said second configuration when run over by a grass mowing device.

17. The marking device of claim 16, wherein when said marker visual element is configured such that when said marker visual element is configured from said second configuration into said first configuration, said marker visual element remains in said first configuration for a predetermined period of time to allow said grass mowing device to clear said marker visual element.

18. The marking device of claim 17, wherein after said predetermined period of time has transpired, said marker visual element automatically configures from said first configuration into said second configuration.

19. A method for marking distance on a golf course, the method comprising:
positioning a marking device at a predetermined position-on the golf course; and
configuring the marking device between a first configuration and a second configuration,
where the marking device includes,
a marker base configured to be positioned within soil; and
a marker visual element, wherein said marker visual element is movably configurable between said first configuration and said second configuration relative to said marker base, wherein
when said marker visual element is in said first configuration, said marker visual element is disposed substantially parallel with a plane of the soil, and
when said marker visual element is in said second configuration, said marker visual element is disposed substantially perpendicular with the plane of the soil.

20. The method of claim 19, wherein the marking device is configurable between said first configuration and said second configuration via manually or automatically via a timer device, a mechanical device and/or an electrical and/or a wireless signal.
